(19) United States
(12) Patent Application Publication
(10) Pub. No.: US 2025/0189466 A1
(43) Pub. Date: Jun. 12, 2025

(54) X-RAY APPARATUS AND RELEVANT OPERATING METHOD FOR THE ANALYSIS OF NONFERROUS METALS

(71) Applicant: DIAMATEX S.R.L., Ciampino RM (IT)

(72) Inventors: Danilo PACELLA, Morlupo RM (IT); Federica CAUSA, Milano MI (IT)

(73) Assignee: DIAMATEX S.R.L., Ciampino RM (IT)

(21) Appl. No.: 18/844,191

(22) PCT Filed: Mar. 20, 2023
(86) PCT No.: PCT/IB2023/052702

§ 371 Date: Sep. 5, 2024

(30) Foreign Application Priority Data
Mar. 21, 2022 (IT) 102022000005489

(51) Int. Cl. G01N 23/2206; G01N 23/20025; H01J 35/14

(52) U.S. Cl. CPC G01N 23/2206; G01N 23/20025; H01J 35/147

(57) ABSTRACT

An X-ray apparatus for the analysis of nonferrous metals includes an X-ray source that produces a low-energy radiation beam and an X-ray spectrometer, these components being arranged close enough to each other and to a sample to be analyzed to be able to simultaneously perform both fluorescence and Compton backscattering analysis using both phenomena to identify both metallic and nonmetallic light materials, particularly for the separation of aluminum and magnesium light alloys.

The present invention relates to an x-ray apparatus for the analysis of nonferrous metals and other light materials, with particular application to the recovery of metals from scrap by separation from other nonmetallic materials.

As is well known, at the end of their lives, cars, and also other industrial and household products of essentially metallic composition, are ground with large hammer mills (so-called car shredders) that reduce them into pieces less than 150 mm in size so as to obtain scrap metal. On leaving these mills, the mixed ground material undergoes a deferrization action using large electromagnetic drums for the purpose of recovering and cleaning up the ferromagnetic steel.

What is discarded by such electromagnetic drums consists mainly of plastics, rubbers, polyurethane foams, glass, aluminum, copper, zinc, zamac, lead, stainless steel, electrical wires, stone residues, iron oxides, and some ferromagnetic steel parts lost during the deferrization action. Next, eddy current and inductive sensor separators are exploited to produce mixed metal concentrates.

Further wet or dry densimetric separation processes allow the separation of light nonferrous metals, such as aluminum and magnesium, from heavy metals such as copper, brass, stainless steel, and lead. The present invention finds application in particular in the subsequent step focusing on the separation of metals of different natures from other materials.

A special feature of this application is that the separation process, to achieve the throughput of at least 1 ton/h typically considered as a minimum for the recycling industry, requires working on high numbers of pieces/hour since the weight of the pieces varies from a few grams (3-4 g) to over 1000 g with an average weight typically ranging from 10 to 50 g. This implies that the separator has a time in the order of milliseconds, typically 5 to 50 ms, to identify the chemical composition of each piece that makes up the material stream.

A type of separator capable of performing this task uses an X-ray technique, referred to as the X-Ray Fluorescence=XRF technique, which allows information on the chemical nature of a material to be gathered through a surface survey, as the signal comes from a few hundred micrometers deep from the surface. Metals are selected using their characteristic fluorescence lines, but the distance between the analysed sample and the X-ray source, which is at least 125 mm, precludes the detection of both low-energy lines and a backscattering signal.

XRF separators that belong to the state of the art cannot reliably identify light metals such as aluminum and magnesium because of the speed of analysis that the application under consideration imposes (a few milliseconds per piece), as the fluorescence phenomenon is very weak for such light metals, while it is significantly more intense for heavier chemical elements (e.g., Ti and up). Therefore, conventional XRF separators perform identification by exclusion, i.e. they consider anything not detected by their fluorescence sensors to be aluminum or magnesium. In the case of material consisting of waste, this is often incorrect because along with metals there may be residual nonmetallic material such as plastic, rubber, wood, etc.

In addition, fluorescence alone indicates the presence of a chemical element but does not provide information about the type of material. For example, the presence of a line of copper does not tell us whether it is a piece of copper or an electronic board with copper tracks or an aluminum alloy of the 2xxx type, the same is true for bromine which may be in a plastic or an electronic board, and similarly the presence of calcium does not indicate whether it is in a plaster, brick, cardboard or plastic with calcium carbonate or whatever.

Another technique that has recently been proposed and implemented for sorting aluminums is the Laser-Induced Breakdown Spectroscopy (LIBS) technique, which is an optical technique of analyzing in the visible/near infrared the fluorescence lines emitted by ablating the surface with a high-power laser. LIBS is a local analysis technique, i.e. it provides the composition of the sample only at the point of analysis, and it is micro-destructive because it alters (in the area of analysis) the material to be selected. LIBS has the disadvantage of being very expensive, cannot be used effectively with transparent materials because the laser beam passes through them without being absorbed, and also does not permit the analysis of many plastic materials because ablation triggers chemical oxidation reactions that irreparably compromise the information on the type of plastic.

It is therefore an object of the present invention to provide an X-ray analysis apparatus that overcomes the above drawbacks. This object is achieved by means of an apparatus that combines an XRF analysis with a Compton effect backscattering signal analysis (X-Ray Fluorescence+BackScattering=XRF-BS), due to the fact that both the X-ray source and the spectrometer are placed closer to each other and also to the sample, the source having also a lower anode-to-cathode voltage and power than those used in prior art XRF separators, so as to emit and detect low-energy X-ray radiation (so-called soft X-rays). Further advantages and features of the present separator are given in the secondary claims.

Thus, the fundamental advantage of the present apparatus is to be applicable to any kind of metal including light metal alloys such as aluminum and magnesium, without requiring any pre-sorting or pre-processing of the analysed material, and to simultaneously identify possible foreign materials (plastics, electronic boards, wood, cardboard, glass, brick, . . . ) composed of light atoms, i.e., with atomic weight less than 14, which may be found mixed together with metals.

Another important advantage of the aforementioned apparatus is its structural simplicity and low cost, since it does not require analyzer components (source, sensors) that are technically different from those used in conventional apparatuses, and it costs substantially the same as they do while providing better performance.

Further advantages and features of the apparatus according to the present invention will be apparent to those skilled in the art from the following detailed description of an embodiment thereof with reference to the attached drawings, in which:

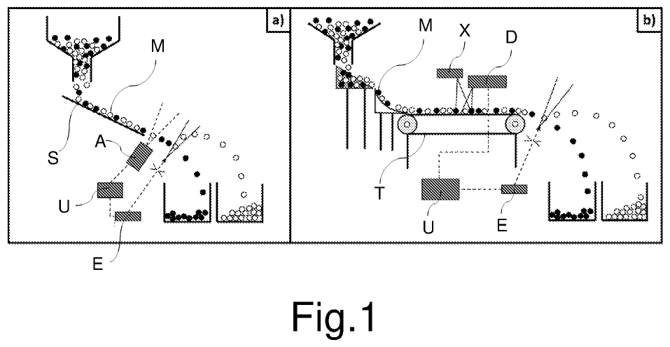

FIG. 1 is a longitudinal sectional view showing schematically the structure of a conventional XRF separator in two possible configurations;

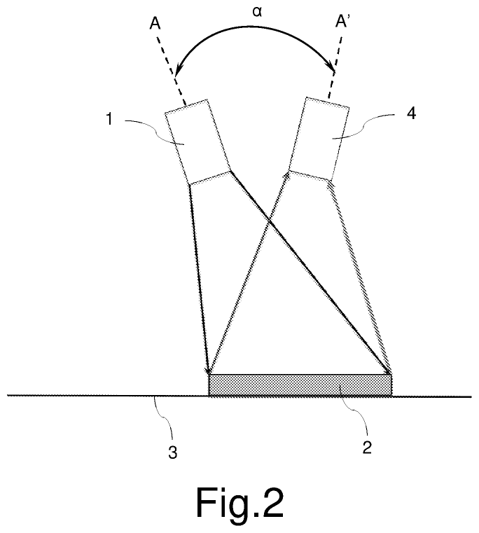

FIG. 2 is a longitudinal sectional view showing schematically the analysis section of an apparatus according to the invention;

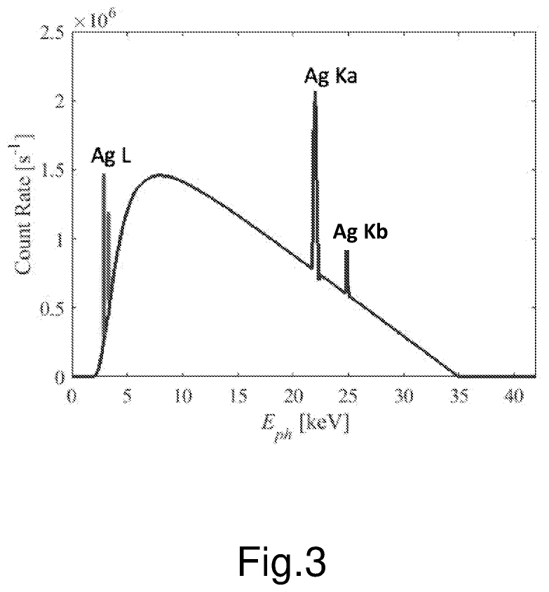

FIG. 3 is a diagram of the spectrum emitted by a silver anode X-ray source fed at 35 kV;

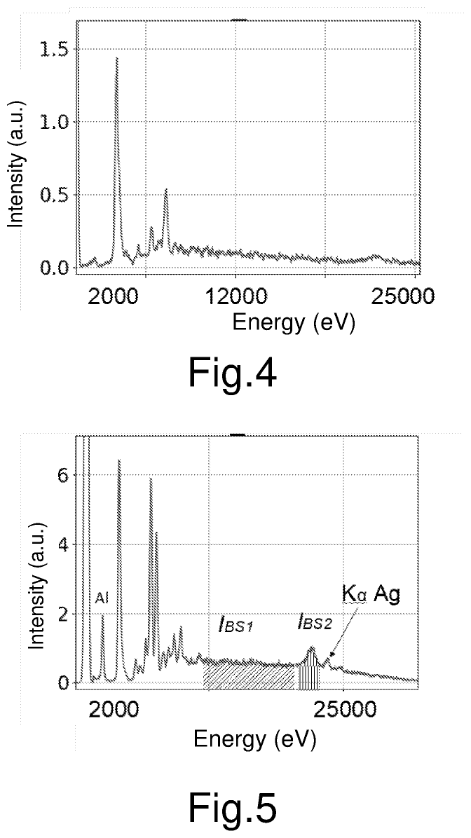

FIG. 4 is a diagram of the X spectrum produced by air, i.e. in the absence of a sample;

FIG. 5 is a diagram of the X spectrum produced by an aluminum sample;

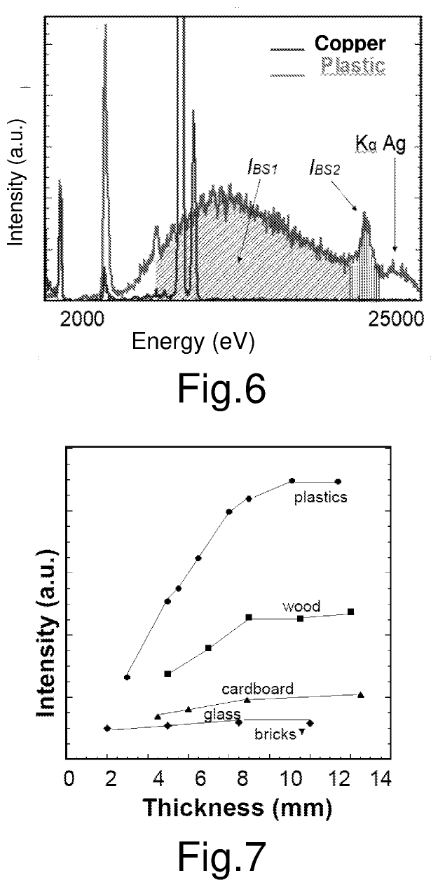

FIG. 6 is a diagram of the X spectrum produced by a plastic sample superimposed on the X spectrum of a copper sample;

FIG. 7 is a diagram showing the intensity of the backscattering signal as a function of sample thickness, for various nonmetallic materials;

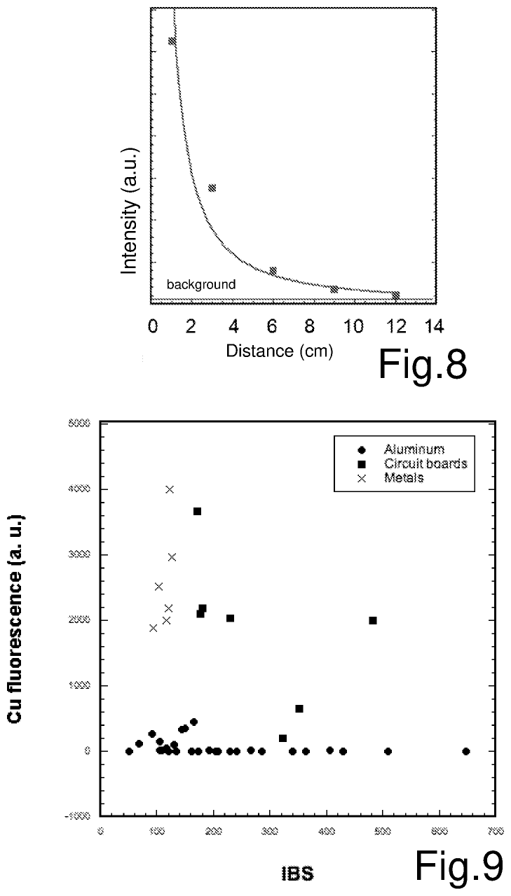

FIG. 8 is a diagram showing the intensity of the backscattering signal as a function of the distance of the sensors from the base of the sample, relative to the background signal;

FIG. 9 is a diagram showing the copper fluorescence line intensity as a function of backscattering signal for different categories of materials; and

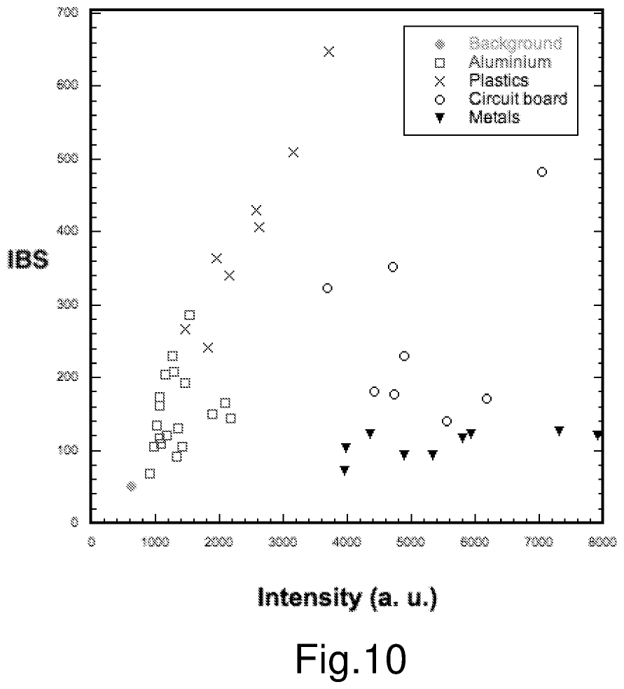

FIG. 10 is a diagram showing the intensity of the backscattering signal as a function of the total number of counts in the spectrum, for different categories of materials.

The typical structure of an XRF separator involves the material being fed by a horizontal conveyor belt with the X-ray source and sensors placed above it, to avoid obstacles to the propagation of the fluorescence signal. Typical values of source-belt distance lie in the range of 125-300 mm, preferably 125-200 mm, and the anode-cathode voltage in the source must be modified according to this distance in order to optimize the fluorescence emission signal. The voltages used lie in the range 25-75 kV, preferably 30-40 kV, with source power of 200-500 W.

An alternative possible configuration is that of “on-the-fly” analysis, i.e. with the pieces falling from the conveyor belt or a chute and the analyzing elements (source, sensors) placed close to the position of the start of the fall, typically below the falling trajectory of the pieces. In this way, the height of the pieces and their arrangement does not affect their distance from the analyzing elements, as is the case when the analysis is performed on the conveyor belt, because the distance from the base of the analyzed sample is constant.

Referring to FIG. 1, it can be seen that a prior art XRF separator can be made in a first configuration (a) for “on-the-fly” analysis in which material M flows down a chute S and as soon as it begins its fall from chute S is analyzed by an analysis system A placed below the fall trajectory. Such an analysis system A includes a suitable X-ray source and a spectrometer, typically an array of fluorescence sensors of the Silicon Drift Detector (SDD) type, for analysis of the ground material M using the XRF technique. The readings from system A are analyzed by a control unit U that commands the control electronics E of a valve, which emits a jet of air to deflect the trajectory of the metal to be recovered. In this way, the metal (white circle) is directed toward a more distant collection container, while the waste material (black circle) proceeds on its path by falling into a closer collection container.

In the second configuration (b), material M is fed by a horizontal conveyor belt T, passing under an X source that emits a beam of radiation capable of causing the fluorescence phenomenon that is detected by an adjacent array of sensors D. As in the previous configuration, the readings from sensors D are analyzed by a control unit U that commands the control electronics E of a valve, which emits a jet of air to deflect the trajectory of the metal to be recovered when it falls from the conveyor belt T.

An XRF-BS separator according to the present invention, whose analysis section is shown in FIG. 2, differs from the known separators described above in that it involves an X-ray source 1 that produces a beam of low-energy radiation (soft X-rays) along an emission axis A using an anode-cathode voltage in the range 25-45 kV and a low power in the range 1-50 W and preferably 5-20 W. Such a beam of soft X-rays illuminates a sample 2 carried by a conveyor belt 3 so as to produce an X-radiation (fluorescence+backscattering) that is detected along a detection axis A′ by an X-ray spectrometer 4 with spectral resolution of at least 10%, preferably about 3-4%. Also in the present apparatus, the spectrometer 4 is placed on the same side as source 1 with respect to sample 2, and typically consists of an SDD-type detector.

The distance along the detection axis A′ between spectrometer 4 and conveyor belt 3, which can be stationary or moving, is in the range 3-100 mm, preferably 10-50 mm for heavy metals and 10-30 mm for aluminum alloys and light metals. Similarly, the distance along the emission axis A between source 1 and conveyor belt 3 is in the range 3-100 mm, preferably 10-60 mm.

In addition, the A-axis along which the beam of soft X-rays is emitted and the detection axis A′ of the X-ray spectrometer 4 form an a-angle of no more than 40° between them, preferably no more than 30° and more preferably no more than 20°.

In fact, Compton scattering occurs in all directions, but the maximum occurs for q=0 (forward scattering) or q=180 degrees (back scattering), where q is the angle between the direction of X-ray propagation and the direction of the photons undergoing scattering. Therefore, the configuration that maximizes the backscattering signal is one in which source and sensor form an angle of 0°, but in reality this is not possible because source and sensor should coincide. However, due to the innovative use of a low-voltage, low-power source, both the X-ray source and SDD detector are small in size so that they can be positioned to form a small a angle between them, typically about 30° or less.

Thanks to the above configuration, the present XRF-BS separator is able to perform an XRF analysis simultaneously with a backscattering signal analysis, using both fluorescence and Compton scattering phenomena caused by the soft X-rays beam. Indeed, an in-depth study of Compton backscattering under the measurement conditions described here, conducted by the inventors with different geometries and materials of various thicknesses, revealed how this physical process carries information about the nature of the material and its thickness, which is particularly important for the recognition of aluminum, magnesium, and light alloys. This information is then exploited for metal recognition, together with fluorescence information.

In this regard, with reference to FIG. 3, it can be seen that the typical emission spectrum of an X-ray source fed at 35 kV is continuous from 2 to 35 keV with the superposition of the characteristic lines of the anode used in the source. For example, with an Ag anode one sees L lines at energies 2.98 keV, 3.15 keV and 3.23 keV; and lines Kₐ at 22.16 keV and K_{b} at 25.15 keV. If sources with other types of anodes are used, the energies of these lines will change, but the general characteristics of these spectra (continuous+lines) will not.

Compton scattering occurs with higher probability for low-energy photons while the energy change increases as the photon energy increases. At higher energy, in this case for the anode's Ag line K_{α}, the collected backscattering photons have energy less than 23 keV (about 21.5 keV) and thus are separated in the spectrum. Photons emitted in the range of 5-20 keV have a high probability of being scattered but are not distinguishable in energy from those emitted, because their energy change is negligible (<3%) and they come from a continuous spectrum. Thus, there are two different backscattering contributions, the continuous one between 5 and 20 keV and the one that is line-like with mean value of about 21.5 keV.

The contribution of the Compton effect for very low energies (<5 keV) is orders of magnitude smaller than that of the photoelectric effect, gradually increasing at energies between 5 keV and 20 keV, where, on the other hand, the contribution of the photoelectric effect decreases rapidly, to reach the same weight as the photoelectric effect in the range 20-50 keV. Since the low energies of the X-ray radiation spectrum are absorbed by the air, by the beryllium window of source 1 and spectrometer 4, we have that most of the backscattering emission is detected above 5 keV.

The backscattering radiation manifests as a continuous portion in the spectrum that overlaps the fluorescence lines, as shown with reference to FIGS. 4-6 in which the spectrum of air, an aluminum sample and a plastic sample are depicted, respectively. In the example shown, two components were identified in the range of 5-25 keV: the first coming from the continuous part of the spectrum, referred to as I_{BS1}, and the second, referred to as I_{BS2}, due to the characteristic line of the source anode material (in this case Ag), particularly the K_{α} line of Ag where the energy increase becomes significant.

More specifically, FIG. 5 depicts the X-spectrum produced by a piece of aluminum in transit at a speed of 2 m/s, in which the fluorescence lines of aluminum and other metals present only in traces emerge above the backscattering continuous portion obtained with the present XRF-BS technique and in an acquisition having a total duration of about 20 ms.

Note that in the case of a relatively heavy metal such as copper, whose spectrum is shown in FIG. 6 superimposed on the plastic spectrum, the backscattering becomes less characterizing since there are essentially only the characteristic lines of the metal. This confirms that the innovative backscattering analysis system of the present invention is particularly effective for the identification of light materials, as defined above.

In practice, the contribution of the continuous portion, I_{BS1}, is measured as the integral of the intensity in the portions of the continuous portion between 5 and 20 keV where no fluorescence lines fall, and this range depends on the type of materials being used. The contribution of the K_{α} line of Ag, I_{BS2}, is measured as a separate contribution in an energy range around 21.5 keV. In both cases, the values of I_{BS1} and I_{BS2} are normalized to the measurement in air, i.e. to the background noise, in order to obtain a pure number:

(I_{BS1})ₛₐₘₚₗₑ/(I_{BS1})_{background} and (I_{BS2})ₛₐₘₚₗₑ/(I_{BS2})_{background}

Thus, these two parameters do not depend on the source current and can be used individually or in combination, depending on their intensity, which depends on the materials. For quick measurements, only I_{BS1} is used because it has higher counts (and therefore lower fluctuations). The backscattering signals I_{BS1} and I_{BS2} change from material to material and are proportional to the thickness of the material, as can be clearly seen from FIG. 7 in the case of plastic, wood, cardboard, glass, and bricks.

FIG. 8 shows that the intensity of the backscattering signal already goes to zero at a distance of 12 cm, reaching the value of the background, and in practice beyond 10 cm the backscattering signal is extinguished and in any case loses the specificity of varying according to the material and its thickness. Therefore, in order to optimize the backscattering signal, the sensor should be located at a few centimeters from the surface of the workpiece to be analyzed, as defined above. Thanks to the special measurement configuration of the present apparatus, it is possible to use the backscattering contribution in the application of the technique called XRF-BS devised and implemented for the first time for the selection and identification of metals, including light metals such as aluminum and magnesium compounds, as well as other nonmetallic materials.

The proximity between source 1, spectrometer 4 and sample 2 also significantly increases the intensity of fluorescence radiation in the low-energy part of the spectrum and minimizes air absorption. An advantage of these two aspects is that the fluorescence and readout efficiency of the elements with peaks at the low energies is significantly increased. As a result, even with short measurement times (5-20 ms), it is possible to detect the fluorescence lines of Al, Si, P, and Cl that go to zero at a distance of 4-5 cm.

As mentioned earlier, fluorescence alone indicates the presence of a chemical element but says nothing about the material. For example, in the diagram in FIG. 9, which includes samples of copper, brass, electronic boards (printed circuit boards) and plastic, the presence of a copper line does not tell us whether it is a copper piece or an electronic board with copper tracks or a 2xxx aluminum alloy.

Instead, backscattering and total intensity of the spectrum provide us with the required discrimination, as shown in FIG. 10 where we can see how the intensity of the Is parameter varies as a function of the number of total counts in the spectrum, measured for different materials (aluminum, metals, printed circuit boards and plastics). The selection of metals by the XRF-BS method does not require pre-sorting or pre-processing of the materials to be selected, as it also recognizes the spurious materials generally present (plastics, boards, etc.).

Simultaneous selection and identification of all materials from a mixed set is then done by a control unit using Is parameters and fluorescence lines appropriately selected according to the materials to be identified. With the XRF-BS technique, heavy metals, light metal alloys, containing a few percentage points of heavy elements can be identified simultaneously with higher accuracy than the state of the art, even in the presence of waste materials such as plastics, boards, or other nonmetallic materials.

It is clear that the XRF-BS technique can also be used for a fixed-sample measurement, for example, for laboratory or quality analysis, which is not difficult because measurements can be made in times of tens of seconds. However, the XRF-BS technique works especially for quick measurements, where one is not interested in analyzing all elements including trace elements, but with the purpose of recognizing the type of material for separation and recycling.

The size of pieces 2 can range from about 10 mm to tens of centimeters, with the speed of conveyor belt 3 appropriately selected (typically 0.5 to 3 m/s) so that the measurement time, i.e., the passage of piece 2 under the beam emitted by source 1, is at least in the order of 10 to 20 ms, depending on the material.

This quick measurement allows a high throughput of pieces, for the typical application of metal identification and separation, for example corresponding to about 30 pieces per second of average size (4-5 cm²), equivalent to 500 kg/h of selected material. For a quantitative example, if the pieces are conveyed in 5 parallel lines that are on a belt with a width of about 1 m, each line having its own analysis section that can process 500 kg/h, a total of 2.5 ton/h is obtained.

To ensure that the reading of the fluorescence signal is correct and independent of the size of the workpiece, source 1 is equipped with a collimator that generates on sample 2 an irradiation zone having a size between 10 and 30 mm in the longitudinal direction of feed of sample 2 and a size between 5 and 20 mm in the direction perpendicular to said longitudinal direction. In this way, the irradiation zone falls completely within sample 2 and the detected signal is indicative only of the material in sample 2 without any part of the radiation ending up on conveyor belt 3.

The passage of each piece at the SDD detector is recorded in a time sequence of spectra, which are recorded preferably every 3 ms, without dead time, transferred to a memory buffer and then analyzed. The beginning and end of the piece are recognized through a system of thresholds, whereby the presence of three or four “empty” spectra indicates that these are two different pieces.

Therefore, the physical distance between the pieces to avoid overlapping depends on the material feed speed on conveyor belt 3, as the distance must correspond to the minimum number of empty spectra needed to distinguish the pieces. For example, when the belt speed is 3 m/s, a minimum distance of about 3 cm between two pieces must be ensured, corresponding to a time of 10 ms in which three or four “empty” spectra are detected. In this way, a zeroed signal is obtained between the two pieces sufficient to be able to identify the end of the first piece and the beginning of the second.

It is clear that the embodiment of the separator according to the invention described and illustrated above is only an example susceptible to many variations. In particular, the separator could also be configured for “on-the-fly” analysis by arranging the analysis section shortly after the beginning of the fall trajectory of the material from a chute or conveyor belt, preferably with the X-ray source and SDD array below said trajectory.

The general XRF-BS analysis method, static or dynamic, according to the invention can thus be summarized in the following steps:
(a) generating along an emission axis A of a low-energy X-radiation beam by means of a source 1 having an anode-cathode voltage in the range 25-45 kV and a power in the range 1-50 W and preferably 5-20 W, said source 1 being arranged at a distance along said emission axis A from a conveyor belt or chute carrying a sample 2 to be analyzed in the range 3-100 mm, preferably 10-60 mm;
(b) directing said X-radiation beam on sample 2 by means of a collimator that generates on sample 2 an irradiation zone having a size between 10 and 30 mm in the longitudinal direction of feed of sample 2 and a size between 5 and 20 mm in the direction perpendicular to said longitudinal direction;
(c) detecting the X-radiation (fluorescence+backscattering) emitted by sample 2 by means of an X-ray spectrometer 4 with a spectral resolution of at least 10%, preferably about 3-4%, placed on the same side of source 1 as sample 2 and arranged at a distance along a detection axis A′ from the conveyor belt or chute in the range 3-100 mm, preferably 10-50 mm for heavy metals and 10-30 mm for aluminum alloys and light metals, the emission axis A forming with the detection axis A′ of said X-ray spectrometer 4 an angle α of not more than 40°, preferably not more than 30° and more preferably not more than 20°;
(d) calculating a first backscattering component I_{BS1} from the continuous portion of the spectrum and a second component I_{BS2} due to the backscattering of the characteristic line of the anode material of source 1, I_{BS1} being measured as the integral of the intensity in the portions of the continuous portion where no fluorescence lines fall, and I_{BS2} being measured as the integral of the intensity in the portion between 88% and 96% of the energy of the characteristic line of the anode;
(e) normalising the values of I_{BS1} and I_{BS2} with respect to the measurement in air to obtain pure numbers;
(f) using one or both of these normalised I_{BS1} and I_{BS2} values in combination with the total intensity of the spectrum and appropriately selected fluorescence lines based on the materials to be identified.

In the typical case of the application of the above method to the separation of metals in an industrial separator as described above, there is also a step (aa), preceding step (a), in which a stream of material containing a plurality of samples 2 is fed to the analysis system at a speed, preferably between 0.5 and 3 m/s, selected so that the measurement time is at least in the order of 10-20 ms, and providing for a distance between two consecutive samples 2 such that at said selected speed said distance corresponds to a sufficient time to detect at least three empty spectra. In addition, steps (c) to (f) are repeated in a time sequence of spectra, which are preferably recorded every 3 ms, with no dead time, transferred to a memory buffer and then analyzed.

1.-7. (canceled)

8. An X-ray analysis apparatus comprising:
an X-ray source configured to emit a radiation beam along an emission axis A towards a sample to be analyzed;
an X-ray spectrometer positioned on the same side of said sample with respect to said X-ray source so as to detect a fluorescence and backscattering spectrum along a detection axis A′ with a spectral resolution of at least 10%; and
a control unit configured to receive readout data from said X-ray spectrometer;
wherein the X-ray source has the following characteristics:
the anode-cathode voltage is in the range 25-45 kV;
the power is in the range 1-50 W;
the distance along said emission axis A from a conveyor belt or chute for conveying the sample is in the range 3-100 mm;
the angle (α) between its emission axis A and the detection axis A′ of the X-ray spectrometer is not more than 40°;
it includes a collimator that generates on the sample an irradiation zone having a size between 10 and 30 mm in the longitudinal direction of feed of sample and a size between 5 and 20 mm in the direction perpendicular to said longitudinal direction;
and wherein the X-ray spectrometer is placed at a distance along the detection axis A′ from said conveyor belt or chute in the range 3-100 mm;
and wherein said control unit is configured for:
(a) calculating a first backscattering component I_{BS1} from the continuous portion of the spectrum and a second component I_{BS2} due to the backscattering of the characteristic line of the anode material of the source, I_{BS1} being measured as the integral of the intensity in the portions of the continuous portion where no fluorescence lines fall, and I_{BS2} being measured as the integral of the intensity in the portion between 88% and 96% of the energy of the characteristic line of the anode;
(b) normalizing the values of I_{BS1} and I_{BS2} with respect to the measurement in air to obtain pure numbers;
(c) using one or both of these normalized I_{BS1} and I_{BS2} values in combination with the total intensity of the spectrum and appropriately selected fluorescence lines based on the materials to be identified.

9. The apparatus of claim 8, wherein the X-ray spectrometer consists of a sensor of the SDD type.

10. The apparatus of claim 8, wherein the X-ray source is provided with a silver anode.

11. A metal separator comprising:
a feed device for ground material containing scrap metal;
an X-ray analysis section of said ground material; and
a control unit configured to receive readout data from said analysis section and to control a valve for emitting an air jet for separating metals;
wherein said analysis section comprises an apparatus of claim 8.

12. The metal separator of claim 11, wherein the analysis section is arranged shortly after the start of the fall trajectory of the ground material from a chute or a conveyor belt.

13. An X-ray analysis method, comprising the steps of:
(a) generating a low energy X-ray radiation beam along an emission axis A by means of a source having an anode-cathode voltage in the range 25-45 kV and a power in the range 1-50 W, said source being arranged at a distance along said emission axis A from a conveyor belt or chute for conveying a sample to be analyzed in the range 3-100 mm;
(b) directing said X-ray radiation beam at said sample by means of a collimator which generates on the sample an irradiation zone having a size between 10 and 30 mm in the longitudinal direction of feed of the sample and a size between 5 and 20 mm in the direction perpendicular to said longitudinal direction;
(c) detecting the X-radiation (fluorescence+backscattering) emitted by the sample by means of an X-ray spectrometer with a spectral resolution of at least 10%, placed on the same side as the source with respect to the sample and arranged at a distance along a detection axis A′ from said conveyor belt or chute in the range 3-100 mm, 10-50 mm for heavy metals and 10-30 mm for aluminum alloys and light metals, the emission axis A forming with said detection axis A′ of said X-ray spectrometer an angle α of not more than 40°;
(d) calculating a first backscattering component I_{BS1} from the continuous portion of the spectrum and a second component I_{BS2} due to the backscattering of the characteristic line of the anode material of the source, I_{BS1} being measured as the integral of the intensity in the portions of the continuous portion where no fluorescence lines fall, and I_{BS2} being measured as the integral of the intensity in the portion between 88% and 96% of the energy of the characteristic line of the anode;
(e) normalizing the values of I_{BS1} and I_{BS2} with respect to the measurement in air to obtain pure numbers; and
(f) using one or both of these normalized I_{BS1} and I_{BS2} values in combination with the total intensity of the spectrum and appropriately selected fluorescence lines based on the materials to be identified.

14. The method of claim 13, wherein step a) is preceded by a step aa) in which a stream of material containing a plurality of samples is individually fed to the analysis system at a speed, between 0.5 and 3 m/s, selected so that the measurement time is at least in the order of 10-20 ms, and providing for a distance between two consecutive samples such that at said selected speed said distance corresponds to a time sufficient to detect at least three blank spectra, and by the fact that steps (c) to (f) are repeated in a time sequence of spectra, which are recorded every 3 ms, with no dead time, transferred to a memory buffer and then analyzed.

15. The X-ray analysis apparatus of claim 8, wherein:
the X-ray spectrometer has a spectral resolution of about 3-4%;
the power of the X-ray source is in the range 5-20 W;
the distance of the X-ray source along the emission axis A from a conveyor belt or chute for conveying the sample is in the range 10-60 mm;
the angle (α) between the emission axis A of the X-ray source and the detection axis A′ of the X-ray spectrometer is not more than 20°; and
the X-ray spectrometer is placed at a distance along the detection axis A′ from the conveyor belt or chute in the range 10-50 mm for heavy metal analysis and 10-30 mm for light metal analysis.

16. The apparatus of claim 15, wherein the X-ray spectrometer consists of a sensor of the SDD type.

17. The apparatus of claim 15, wherein the X-ray source is provided with a silver anode.

18. A metal separator comprising:
a feed device for ground material containing scrap metal;
an X-ray analysis section of said ground material; and
a control unit configured to receive readout data from said analysis section and to control a valve for emitting an air jet for separating metals;
wherein said analysis section comprises an apparatus of claim 15.

19. The metal separator of claim 18, wherein the analysis section is arranged shortly after the start of the fall trajectory of the ground material from a chute or a conveyor belt.
